(19) United States
(12) Patent Application Publication
(10) Pub. No.: US 2004/0216932 A1
(43) Pub. Date: Nov. 4, 2004

(54) Hybrid wheel and track vehicle drive system

(75) Inventors: Anthony J. Giovanetti, San Jose, CA (US); Lorin C. Dueck, San Jose, CA (US); Raymond L. Hickman, Gilroy, CA (US)

Correspondence Address: Patterson, Thuente, Skaar & Christensen, P.A., 4800 IDS Center, 80 South 8th Street, Minneapolis, MN, 55402-2100, US

(73) Assignee: United Defense, LP, Arlington, VA

(21) Appl. No.: 10/851,346

(22) Filed: May 21, 2004

Related U.S. Application Data
(63) Continuation of application No. 10/192,573, filed on Jul. 9, 2002.
(60) Provisional application No. 60/304,213, filed on Jul. 9, 2001.

(51) Int. Cl. B62D 55/06

(52) U.S. Cl. 180/9.1

(57) ABSTRACT

A vehicle drive system includes a hybrid wheel and track system, having a drive wheel operably coupled to a motive source, the motive source for imparting rotational motion to the drive wheel, the drive wheel having an axis of rotation, an idler wheel displaced from the drive wheel and rotationally coupled to the drive wheel by a continuous track; and a cantilever beam supporting the idler wheel and being rotatable as desired about the drive wheel axis of rotation. A device and method for controlling a suspension are further included.

### RELATED APPLICATIONS

This application is a continuation application of U.S. application Ser. No. 10/192,573 filed Jul. 9, 2002, which claims priority from U.S. provisional application No. 60/304,213, filed Jul. 9, 2001, the entire contents of which are incorporated herein by reference.

### BACKGROUND OF THE INVENTION

1. Field of the Invention

The present invention relates generally to vehicles, and more particularly to a vehicle drive system.

2. Description of the Prior Art

There are many applications for unmanned vehicles, both in military and civilian contexts. The typical scenario for the use of unmanned vehicles is when the environment would be hazardous to human operators, such as an area of high radiation, intense heat or fire, smoke, dust, etc. Other hazardous conditions are found in operations such as searches for explosives. In still other instances, the geometry of the area in which the operation is to take place might be so small, e.g. narrow hallways or stairs, as make the use of manned vehicles non-feasible. In all of these situations, and many others, it is desirable to have an unmanned vehicle that can carry various required payloads.

The prior art has some examples of unmanned vehicles of the type that are the subject of the present invention. U.S. Pat. No. 5,022,812, the “Small All Terrain Mobile Robot”, issued to Coughlan et al., on Jun. 11, 1991, discloses one such example. The “All Terrain Mobile Robot”, issued to White et al., U.S. Pat. No. 4,932,831, on Jun. 12, 1990, discloses a predecessor of the Coughlan device.

Some of the limitations of the prior art are as follows:

1. Drive wheel and idler tracks are not integrated on a common cantilever beam

2. Lack of independently moveable cantilever beams and tracks

3. Lack of independently driven tracks

4. Lack of “band track” style tracks

5. Not designed for low acoustic, thermal, or radio frequency signatures

6. Not recoverable from rollover

7. Operation is tethered vs. control using a radio link

Accordingly, the object of the present invention is to provide an unmanned, remotely controlled device that overcomes the limitations listed above.

### SUMMARY OF THE INVENTION

The present invention is an all terrain, hybrid wheel and track, unmanned ground vehicle that is remotely or automatically piloted through a radio link using on board cameras, sensors, and computers. The vehicle comprises four identical and independently driven hybrid wheel/track assemblies, generally situated at the four corners of a chassis. Each hybrid wheel/track assembly includes a band track segment that connects a large drive wheel to a smaller idler wheel that is affixed to the end of a cantilever beam. Each cantilever beam can be independently rotated up or down through an arc of plus or minus 90 degrees about the axis of rotation of the drive wheel. The hybrid wheel and track assembly configuration disclosed herein permits the vehicle to adjust its ground clearance, to climb steep and slippery slopes, to travel over uneven and rocky terrain, to bridge ditches, and to negotiate vertical obstacles like concrete walls, fences, and barricades. Further, each of the cantilever beams is sufficiently long so that in the event of a rollover of the vehicle, the respective hybrid wheeltrack assemblies can be individually and variously articulated so as to automatically right the vehicle. tracked segments can be articulated so as to automatically right the vehicle.

Other unique features of the present invention include a multifuel, rotary engine that will operate at full power even while the vehicle is inverted, and a serial hybrid electric drive system consisting of an engine driven generator, battery storage, and in-hub electric wheel motors. The electric drive system enables the vehicle to move even when the engine is turned off or when the vehicle is at least partially submerged under water as it travels along the bottom of a river or a lake. In addition, the four symmetrical hybrid wheel/track assemblies are capable of skid steering and also allow the vehicle to move in both forward and reverse directions at the same speed, which gives the vehicle good mobility even in very confined spaces. Further, the clam-shell style body hull adapts to carry different military of police payload modules, including but not limited to guns, missiles, non-lethal munitions, tear gas, vertical launch unmanned aerial vehicles, other small robotic ground vehicles, and specialized sensing and camera equipment for reconnaissance, surveillance, hazardous material handling, and hostage-terrorist scenarios.

Finally, in order to dramatically increase its range and duration of missions, the vehicle is capable of positioning itself over an upright or overturned 55-gallon fuel container and refueling itself automatically using a specially designed probe that pierces and draws fuel from the container.

The present invention is A vehicle drive system includes a hybrid wheel and track system, having a drive wheel operably coupled to a motive source, the motive source for imparting rotational motion to the drive wheel, the drive wheel having an axis of rotation, an idler wheel displaced from the drive wheel and rotationally coupled to the drive wheel by a continuous track; and a cantilever beam supporting the idler wheel and being rotatable as desired about the drive wheel axis of rotation. A device and method for controlling a suspension are further included.

An advantage of the present invention is that each of the four hybrid wheel/track assemblies are independently driven.

Another advantage of the present invention is that the vehicle uses a multi-fuel engine for versatility.

A still further advantage of the present invention is that the vehicle can operate in virtually any terrain, including in limited underwater operations.

Yet another advantage of the present invention is that the constraints present for manned vehicles, such as human comfort factors, survivability, toxic fume limitations, and the prohibition of underwater and inverted operation, are either greatly reduced or completely removed.

These and other objects and advantages of the present invention will become apparent to those skilled in the art in view of the description of the best presently known mode of carrying out the invention as described herein and as illustrated in the drawings.

### BRIEF DESCRIPTION OF THE DRAWINGS

FIG. 1 is a perspective view of the all terrain, hybrid wheel and track, unmanned ground vehicle of the present invention with the upper portion of the clam-shell hull removed.

FIG. 2 shows the vehicle in a high ground clearance configuration.

FIG. 3 shows the vehicle in an underwater operation configuration.

FIG. 4 shows the vehicle in transport and road travel mode.

FIG. 5 shows the vehicle in a low ground pressure configuration.

FIG. 6 shows the vehicle in a configuration adapted for obstacle negotiation.

FIG. 7 is a schematic view of the weapons platform electric propulsion system.

FIGS. 8-10 illustrate the vehicle with mission-specific payloads.

FIG. 11 is a chart showing the range and fuel consumption of the vehicle versus number of days deployed.

FIG. 12 shows the acceleration loads for a 0.25 m step obstacle encountered at a travel speed of 32 km/hr.

FIG. 13 shows the acceleration loads for a 1.0 m step obstacle encountered at a travel speed of 1.6 km/hr.

### DETAILED DESCRIPTION OF THE INVENTION

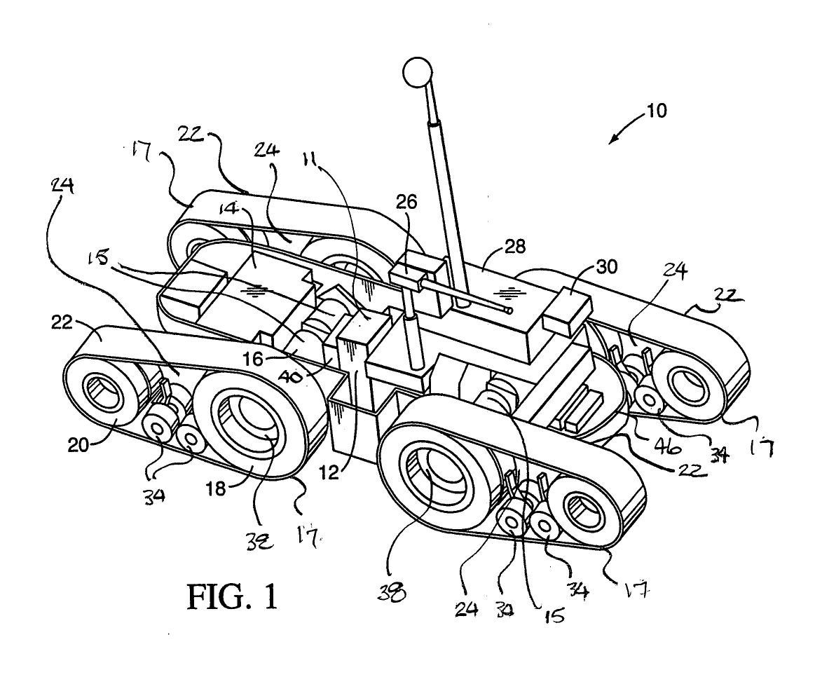

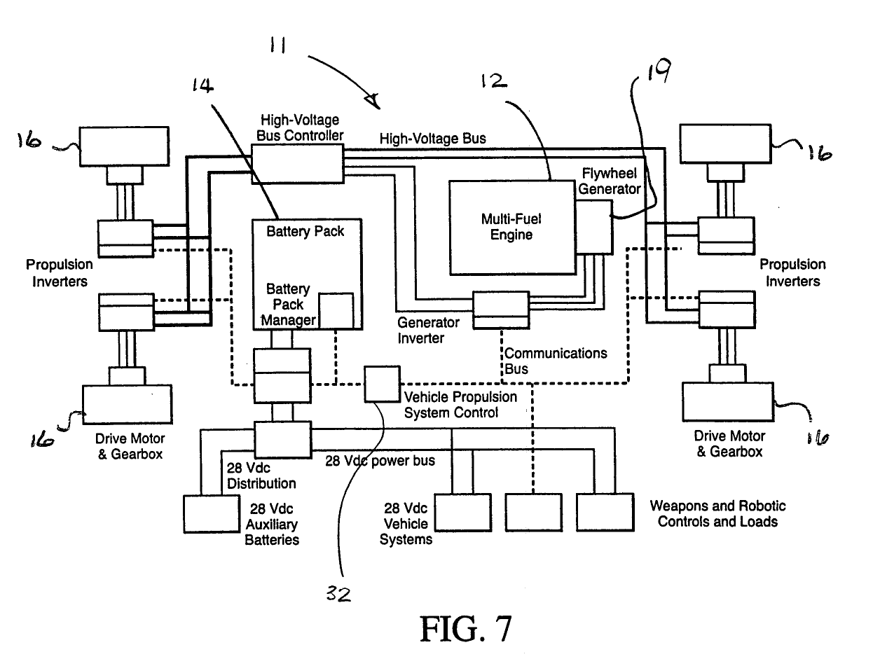

Referring first to FIGS. 1 and 7, the present invention is a fuel-efficient, highly mobile, robotic vehicle 10 capable of extended duration missions. The vehicle 10 is powered by a hybrid power plant 11 comprising a rotary engine 12 and batteries 14. The power is transmitted to the vehicle 10 by a hybrid electric drive of the hybrid power plant 11.

The hybrid multi-fuel/electric energy storage and power conversion design 11 utilized in the present invention results in superior fuel efficiency. The vehicle 10 uses a hybrid multifuel/electric energy storage power plant 11 as illustrated in FIG. 7. Control algorithms in an on board computer keep the rotary engine 12 operating at its most fuel-efficient point. The engine 12 is sized for average power and is supplemented by the battery pack 14 for transient peak power requirements. The batteries 14 allow silent mobility, silent watch, and extended operation of the vehicle 10. A generator 17 for the battery pack 14 is powered by the engine 12.

The rotary engine 12 is both turbocharged and intercooled. It is therefore well suited for hybrid electric use because of its high efficiency (SFC 230 g/kwh to 255 g/kwh), high speed, low noise, low vibration, and low magnetic signature. Furthermore, the engine 12 has multifuel capability (the ability to operate on more than one fuel, including gasoline, kerosene, or diesel fuels which may be recovered from abandoned enemy vehicles or stockpiles), the ability to operate at full power even while inverted, and excellent cold temperature startup capability. In order to dramatically increase range and duration of missions, the vehicle 10 is capable of positioning itself over an upright or overturned 55-gallon fuel container and refueling itself automatically using a specially designed probe that pierces and draws fuel from the container.

In the preferred embodiment, the individual batteries 14 comprising the battery pack 14 are state-of-the-art, high energy density, manganese-based batteries specifically designed for and currently used in consumer automotive traction applications.

The electric drive motor 16 of the vehicle 10 power four identical and independently driven hybrid wheel/track drive assemblies (HWTAS) 17 generally situated at the four corners of a chassis.

Drive motors 16 rotationally drive the respective large drive wheels 18 which in turn impart motion to the band tracked segments 22, which in turn impact rotational motion to the idler wheels 20. The individually controlled electric wheel drive motors 16 balance wheel torque for improved traction and provide superior control and regenerative braking to capture excess kinetic energy. Each track segment 22 connects a large drive wheel (main road wheel) 18 to a smaller idler wheel 20 that is affixed to the end of a cantilever beam (track arm) 24. Each cantilever beam 24 can be independently rotated up or down through an arc of plus or minus 90 degrees about the axis of rotation of the respective drive wheel 18. The hybrid wheel and track configuration of each HWTAS 17 permits the vehicle 10 by rotating the respective cantilever beams 24 to adjust its ground clearance, to climb steep and slippery slopes, to travel over uneven and rocky terrain, to bridge ditches and to negotiate vertical obstacles like concrete walls, fences, and barricades. Further, each of the cantilever beams 24 of the respective is sufficiently long so that in the event of a rollover of the vehicle 10, the cantilever beams 24 of the respective HWTA's 17 can be individually articulated so as to automatically right the vehicle.

The vehicle 10 includes a variable-geometry suspension system incorporated in each HWTA 17 that provides exceptional mobility. The innovative variable-geometry suspension system of the HWTA 17 comprises a combination of three key features: sprung bogie wheels 34 on the band track (track segments 22) assembly, “run-flat” pneumatic tires as the main road wheels 18, and a hydraulically-actuated swiveling suspension arm (cantilever beam 24). The electronically-controlled suspension (ECS) 32 (see FIG. 7) automatically sets suspension performance and configuration. The ECS 32 actuator is powered by an engine-driven ECS hydraulic motor that moves and supports the arm (cantilever beam 24) so that suspension bogie wheels 34 and track 22 are pressed to the ground. A gas-charged ECS accumulator maintains pressure on the ECS hydraulic motor, which in turn provides spring motion to the suspension arm (cantilever beam 24). Motion damping and shock absorption are provided by an electronically-controlled ECS valve, which bypasses the high pressure side of the ECS hydraulic motor to the low-pressure side.

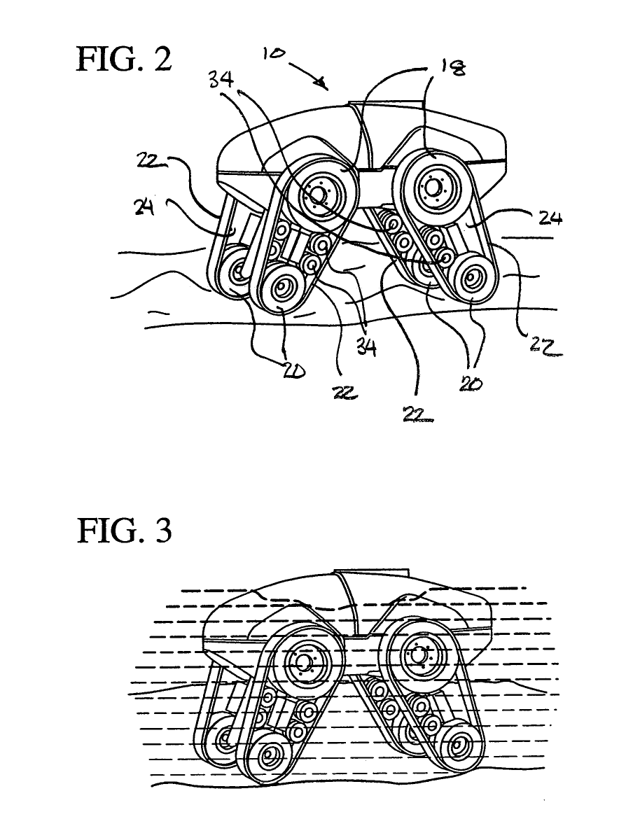

The ECS 32 increases or decreases suspension stiffness and damping coefficient depending on terrain roughness and speed of vehicle 10. In addition, the ECS 32 adjusts pneumatic tire pressure of drive wheel 18 on the run to modify suspension compliance. The ECS 32 controller raises the track arms (cantilever beams 24) to variable positions so that the vehicle can assume differing configurations, as noted in relation to FIGS. 2-6 below.

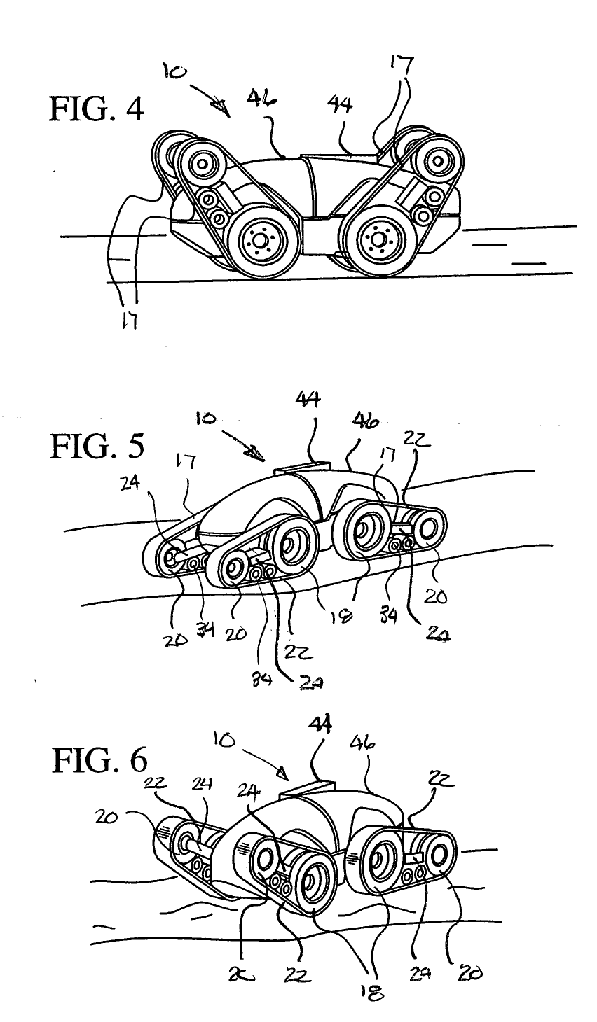

Referring now to FIGS. 2-6, the track arms (cantilever beams 24) are rotatably raised to their full extension supporting the vehicle 10 on the respective idler wheels 20 to maximize ground clearance for both the rough terrain crossing and obstacle traversing mode (FIG. 2), and for water submerged travel (FIG. 3). In the flat position (FIG. 5), resulting from vehicle 10 weight ground pressure is reduced to a minimum for traveling on soft snow, sand, or mud. The track suspension arms 24 are raised automatically for minimum drag in the pivot steer (as an alternative to drag or skid steering) mode (FIG. 4) for transport and relatively high speed traveling on roads. The ECS 32 varies the approach angle to an obstacle by raising the idler wheels 20 of the leading two HWTA's 17 on the vehicle 10 when in obstacle negotiation mode (FIG. 6, discussed in further detail below). In addition, the four symmetrical track segments 22 of the respective HWTA's 17 combined with the use of skid steering allow the vehicle 10 to move both forward and in reverse at the same speed. This capability gives the vehicle 10 good mobility even in very confined spaces.

The ECS 32 automatically levels the vehicle 10 on slopes or uneven ground and assists in self-recovery if the vehicle 10 tips. Hydraulic disc brakes 38 supplement the intrinsic dynamic braking of the four drive motors 16. The disc brakes 38 also function as the parking brake. A small, battery 14 powered electrically-driven, auxiliary hydraulic pump 40 is used to provide suspension, braking, and weapon system movement during stealth mode, when the engine 12 is not running.

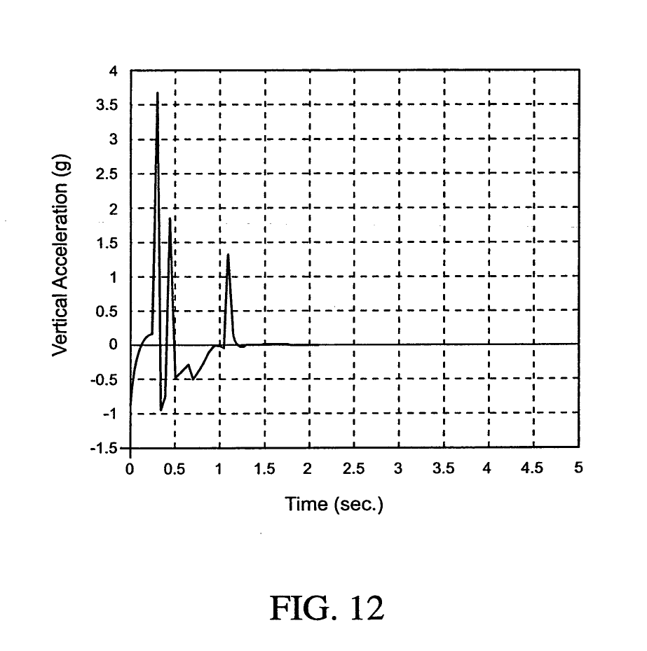

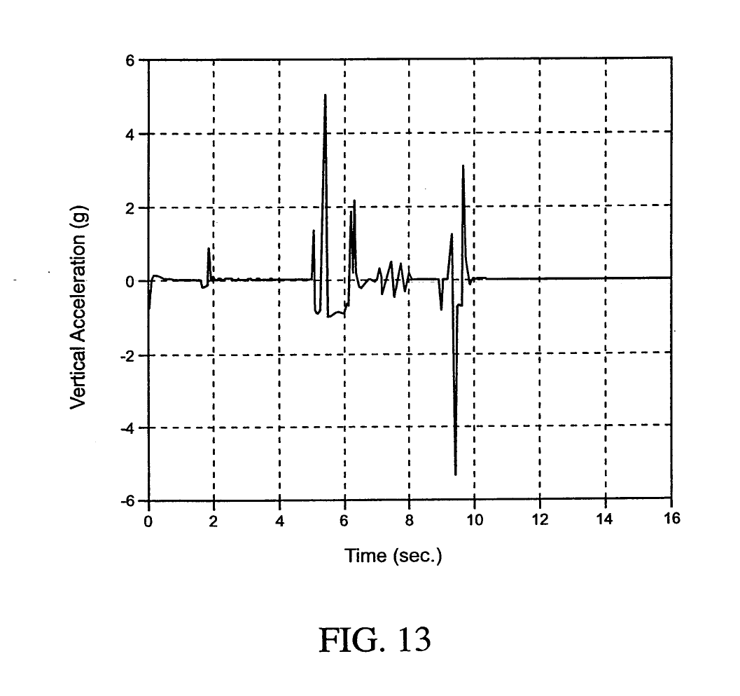

In order to efficiently negotiate obstacles, the vehicle 10 uses tracks 22 with an automatically controlled angle of approach as depicted in FIG. 6. The vehicle 10 is able to negotiate up to 1.1 m (44 inch) vertical obstacles, and it crosses 0.25 m (10 inch) obstacles without slowing down. FIG. 12 shows the vertical acceleration versus time for a 0.25 m step obstacle encountered at 32 km/hr. Similarly, FIG. 13 shows that a 1 m step obstacle can be safely negotiated at 1.6 km/hr.

The unmanned ground vehicle 10 is remotely or automatically piloted through a radio link using on board cameras and sensors 30 and a common RST (reconnaissance, surveillance, and targeting) module 28. The sensors 30 assist in detecting both positive and negative obstacles.

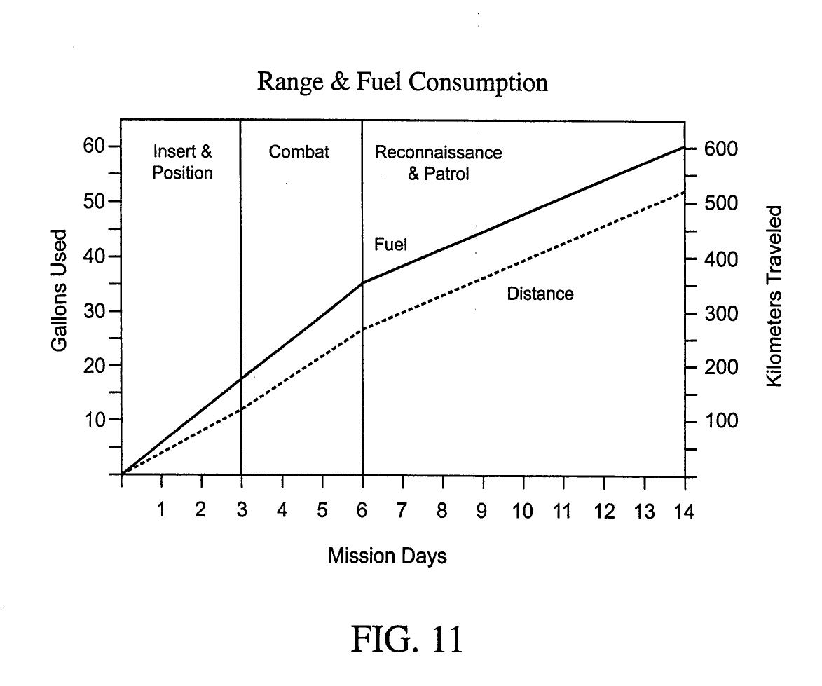

The combination of a wheel drive (see FIG. 4) in tandem with track drive (see FIGS. 5, 6) gives the unmanned ground vehicle 10 of the present invention unexpectedly high performance relative to prior art devices. In addition to the unique handling characteristics described above, the vehicle 10 possesses outstanding endurance, capable of being operated continuously for 14 days over 520 km, as illustrated in FIG. 11.

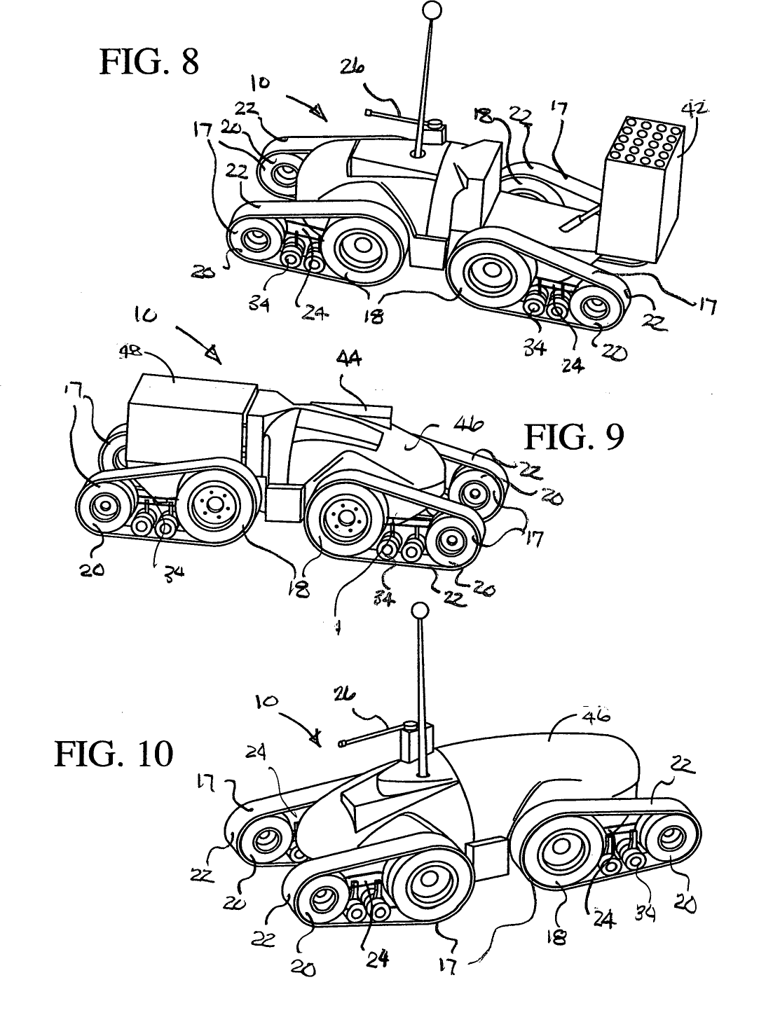

The vehicle 10 is also quite versatile. As shown in FIGS. 8-10, the payload carried can include many different mission-tailored weapon modules. The clam-shell style body 46, as depicted in FIG. 10, readily adapts to carry different military or police payload modules, including but not limited to guns, missiles, non-lethal munitions, tear gas, vertical launch unmanned aerial vehicles, other small robotic ground vehicles, and specialized sensing and camera equipment for reconnaissance, surveillance, hazardous material handling, and hostage/terrorist scenarios. A self-defense weapon 26 (FIG. 8) can also be easily included on an upper surface of the vehicle 10. Exemplary weapons include surface-to-air missiles (Stinger or Javelin) 42, depicted in FIG. 8, and direct fire weapons (25 and 30 mm cannon) 44 with a munitions compartment 48, depicted in FIG. 9.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

What is claimed is:

1. A vehicle drive system, comprising:
a hybrid wheel and track system, having;
a drive wheel operably coupled to a motive source, the motive source for imparting rotational motion to the drive wheel, the drive wheel having an axis of rotation;
an idler wheel displaced from the drive wheel and rotationally coupled to the drive wheel by a continuous track; and
a cantilever beam supporting the idler wheel and being rotatable as desired about the drive wheel axis of rotation.

2. The vehicle drive system of claim 1 being incorporated in a vehicle employing a plurality of such hybrid wheel and track systems.

3. The vehicle drive system of claim 1 including bogie wheels disposed between the drive wheel and the idler wheel.

4. The vehicle drive system of claim 1, the cantilever beam being rotatably shiftable through at least 90 degrees as desired.

5. The vehicle drive system of claim 1, the cantilever beam being rotatably shiftable to at least selectively present a portion of the track that is only supported by the idler wheel to a ground surface, to present a portion of the track that is only supported by the drive wheel to a ground surface, and to present a portion of the track that is supported by both the idler wheel and the drive wheel to a ground surface.

6. An electronically controlled suspension system, comprising:
(1) a hybrid wheel and track system, having;
a drive wheel operably coupled to a motive source, the motive source for imparting rotational motion to the drive wheel, the drive wheel having an axis of rotation;
an idler wheel displaced from the drive wheel and rotationally coupled to the drive wheel by a continuous track;
a cantilever beam supporting the idler wheel and being rotatable as desired about the drive wheel axis of rotation; and
(2) a controller for controlling operating parameters of the hybrid wheel and track system.

7. The electronically controlled suspension system of claim 6 being incorporated in a vehicle employing a plurality of such hybrid wheel and track systems.

8. The electronically controlled suspension system of claim 6, the controller being operably coupled to the cantilever beam for rotatably shifting the cantilever beam through at least 90 degrees as desired.

9. The electronically controlled suspension system of claim 6, the controller being operably coupled to the cantilever beam for rotatably shifting the cantilever beam to at least selectively present a portion of the track that is only supported by the idler wheel to a ground surface, to present a portion of the track that is only supported by the drive wheel to a ground surface, and to present a portion of the track that is supported by both the idler wheel and the drive wheel to a ground surface.

10. The electronically controlled suspension system of claim 6, the controller increasing/decreasing suspension stiffness of the hybrid wheel and track system responsive to terrain and vehicle speed.

11. The electronically controlled suspension system of claim 6, the controller adjusting tire pressure of the drive wheel as desired during operation to modify suspension compliance of the hybrid wheel and track system.

12. The electronically controlled suspension system of claim 6, the controller controlling the cantilever beam to affect a vehicle ground clearance.

13. The electronically controlled suspension system of claim 6, the controller controlling the cantilever beam to affect the angle of approach of the hybrid wheel and track system to an obstacle.

14. A method of controlling a suspension system, comprising:
providing a hybrid wheel and track system, having;
a drive wheel operably coupled to a motive source, the motive source for imparting rotational motion to the drive wheel, the drive wheel having an axis of rotation;
an idler wheel displaced from the drive wheel and rotationally coupled to the drive wheel by a continuous track;
a cantilever beam supporting the idler wheel and being rotatable as desired about the drive wheel axis of rotation; and
controlling operating parameters of the hybrid wheel and track system system by means of a controller.

15. The method of claim 14, including operably coupling the controller to the cantilever beam and rotatably shifting the cantilever beam through at least 90 degrees as desired.

16. The method of claim 14, including operably coupling the controller to the cantilever beam and rotatably shifting the cantilever beam to at least selectively present a portion of the track that is only supported by the idler wheel to a ground surface, to present a portion of the track that is only supported by the drive wheel to a ground surface, and to present a portion of the track that is supported by both the idler wheel and the drive wheel to a ground surface.

17. The method of claim 14, including increasing/decreasing suspension stiffness of the hybrid wheel and track system responsive to terrain and vehicle speed by means of the controller.

18. The method of claim 14, including adjusting tire pressure of the drive wheel as desired during operation to modify suspension compliance by means of the controller.

19. The method of claim 14, including controlling the cantilever beam of the hybrid wheel and track system to affect a vehicle ground clearance by means of the controller.

20. The method of claim 14, including controlling the cantilever beam of the hybrid wheel and track system to affect the angle of approach of the hybrid wheel and track system to an obstacle by means of the controller.
